(19) United States
(12) Patent Application Publication
(10) Pub. No.: US 2012/0042975 A1
(43) Pub. Date: Feb. 23, 2012

(54) PRESSURE RELIEF VALVE WITH SMALL DIMENSIONS

(75) Inventors: Herbert Stotkiewitz, Bietigheim-Bissingen (DE); Hans-Peter Stadel, Lorch (DE); Juergen Haak, Roermond (NL)

(73) Assignee: ROBERT BOSCH GMBH, Stuttgart (DE)

(21) Appl. No.: 13/148,984

(22) PCT Filed: Jan. 11, 2010
(86) PCT No.: PCT/EP2010/050214

§ 371 Date: Nov. 7, 2011

(30) Foreign Application Priority Data
Feb. 12, 2009 (DE) 1020090008063

(51) Int. Cl. F16K 15/14

(52) U.S. Cl. 137/843

(57) ABSTRACT

The invention relates to a pressure relief valve for a packaging container (3), comprising a base body (4) with at least one through opening (9, 29), a sealing surface (14) and a peripheral region (18), wherein the peripheral region (18) may be sealably connected to an inner surface (3a) of the packaging container (3), the sealing surface (14) having an inwardly tapering form and a flexible membrane (6), in contact with the sealing surface (14) of the base body (4) to generate a sealing effect. The membrane (6) covers the through opening (9), a fluid (5) is arranged between the sealing surface (14) and the membrane (6), wherein a recess (10) is formed in the base body (4) to accommodate thee membrane (6). The recess (10) has a first diameter (D1), between 70 and 80% of a total diameter (D2) of the base body (4).

### BACKGROUND OF THE INVENTION

The present invention relates to a pressure relief valve for a packaging container, which valve has very small dimensions.

Various embodiments of pressure relief valves for packaging containers are known from the prior art. The use of valves, especially on flexible packages for foodstuffs, has already been implemented by a large number of technical variants. A principal requirement on valves of this kind is that they should permit only slight excess pressures in the package through appropriate opening and otherwise should reliably prevent the penetration of ambient air. In this context, the penetration of ambient air must be prevented even when the pressure in the package is very low. In practice, however, the two above-mentioned aims are in conflict since, on the one hand, the pressure for opening the valve should only be low and, on the other hand, high vacuum tightness should be provided. Valves which have a high vacuum tightness therefore also have a very high opening pressure. In contrast, valves with only a low opening pressure do not have the necessary vacuum tightness.

EP 1 802 537 B1 has disclosed a pressure relief valve which is designed to be uneven in part in a recess in a main body. This results in differences in the distance between the recess and a valve diaphragm in different zones. This valve has fundamentally proven its worth but very recently there have been an increasing number of uses which require an improved opening characteristic and vacuum tightness.

### SUMMARY OF THE INVENTION

In contrast, the pressure relief valve according to the invention, has the advantage that it opens even at very small excess pressures above ambient pressure of less than 1000 Pa (10 mbar), more particularly less than 500 Pa (5 mbar) and has a very high vacuum tightness at a pressure difference of over 60000 Pa between the inside and the outside of the packaging. Moreover, the pressure relief valve according to the invention is of very small size, enabling it to be attached very inconspicuously to the package. On the one hand, reducing the dimensions of the pressure relief valve reduces the cost of materials and, more particularly, allows greater variation in the positioning of the pressure relief valve on the package. Furthermore, it is possible to achieve improved application of the pressure relief valve to the package since the sealing forces to be applied are smaller owing to the smaller sealing area. In addition, the pressure relief valve has just two main components, namely a main body and a diaphragm. According to the invention, this is achieved by virtue of the fact that the main body has a recess to accommodate the diaphragm, the diaphragm having a first diameter. In this arrangement, the main body is formed as a short cylinder and has a second diameter. Here, the length of the first diameter is between 70 and 80% of the second diameter, preferably 75% of the second diameter. A maximum value for the second diameter is about 13.5 to 15.5 mm. An inwardly tapering sealing surface, on which the diaphragm rests sealingly, is furthermore provided on the main body and a fluid is arranged between the diaphragm and the sealing surface. The effect of the tapering sealing surface is to bring about differences in the thickness of the film of fluid formed between the sealing surface and the diaphragm and, more particularly, a thinner film of fluid is provided on the radially outer side of the sealing surface than on a radially inner side. This results in different adhesion forces and capillary forces, which are smaller on the radially inner side and allow easier opening by excess pressure, and are greater on the radially outer side and ensure improved vacuum tightness.

An inner annular groove is preferably in the main body radially to the inside of the sealing surface. A central base region, in which one or more through openings are arranged, is formed to the inside of the inner annular groove. It is thereby possible to provide a particularly robust main body that satisfies even the highest pressure requirements.

More preferably, an outer annular groove is arranged in the main body radially to the outside of the sealing surface. In this arrangement, the outer annular groove directly adjoins the peripheral region 18. This makes it possible to ensure that a dimension or diameter of the main body is as small as possible.

According to another preferred embodiment of the invention, the main body comprises a multiplicity of retaining elements, which are arranged on the peripheral region and are formed integrally with the main body. Here, the retaining elements prevent the diaphragm from falling out, thereby making it possible to dispense with a separate part for holding down the diaphragm.

A multiplicity of noses that project radially inward is furthermore arranged on the main body, the noses centering the diaphragm between them. This makes it possible to achieve reliable and simple positioning of the diaphragm both during assembly and during operation.

A level of the central base region is preferably the same as a level of an inner edge on the sealing surface. In this context, the term “level” refers to a plane perpendicular to a center line of the pressure relief valve, a higher level indicating that said level is closer to the package wall.

According to another preferred embodiment of the present invention, the through opening comprises perforations, which are arranged on a bottom in the through opening. The perforations can be arranged symmetrically or asymmetrically. The perforations are each formed by a multiplicity of microholes, a microhole having a diameter of from 30 to 120 μm.

More preferably, the diaphragm has a deformable or soft surface. This soft surface of the diaphragm makes it possible for said diaphragm to be deformed at the sealing surface of the main body during sealing and thus to contribute to a further improvement in sealing.

More preferably, the peripheral region of the main body has an inner ring, an outer ring and a central ring, the central ring projecting further from a base surface than the inner ring and the outer ring. It is thereby possible, during a sealing operation to fix the pressure relief valve on an inner side of a package, to ensure that particles formed during the sealing operation, for example, fall into the annular interspaces between the inner ring and the central ring or between the central ring and the outer ring, and cannot enter the pressure relief valve.

The pressure relief valve according to the invention is preferably used in food packaging, especially that for powdered goods, e.g. coffee.

### BRIEF DESCRIPTION OF THE DRAWINGS

Preferred illustrative embodiments of the invention are described in detail below with reference to the accompanying drawing, in which:

FIG. 1 is a schematic sectional view of a pressure relief valve in accordance with a first illustrative embodiment of the invention,

FIG. 2 is a schematic sectional view of a partial area of a main body of the pressure relief valve in FIG. 1,

FIG. 3 is a schematic plan view of the main body in FIG. 1,

FIG. 4 is a schematic sectional view of a main body of a pressure relief valve in accordance with a second illustrative embodiment, and

FIG. 5 is a schematic plan view of the main body in FIG. 4.

### DETAILED DESCRIPTION

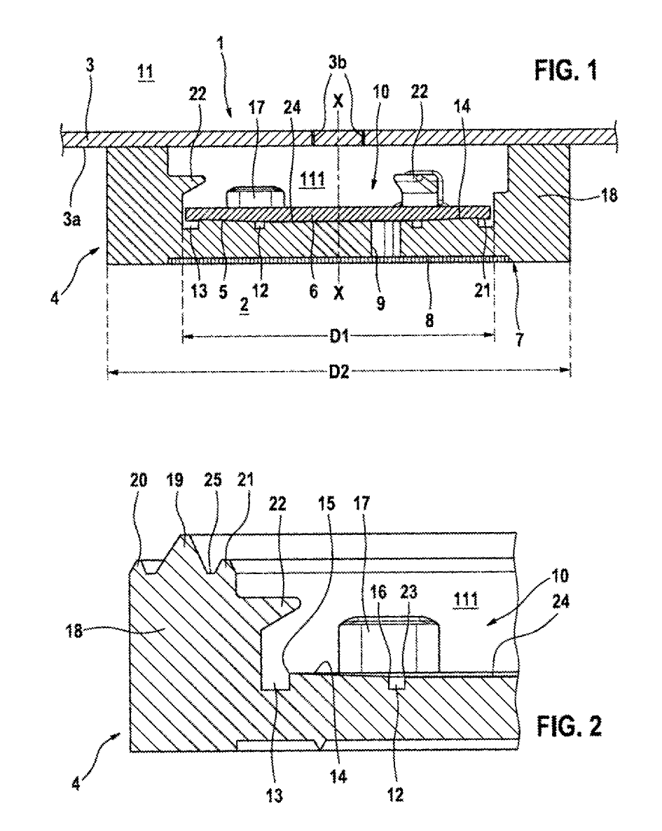

A pressure relief valve 1 in accordance with a first preferred illustrative embodiment of the invention is described in detail below with reference to FIGS. 1 to 3.

As can be seen from FIG. 1, the pressure relief valve 1 according to the invention comprises a main body 4 and a diaphragm 6. The pressure relief valve 1 is fixed on an inner side 3a of a package 3 by means of a sealing operation. Openings 3b, under which the pressure relief valve 1 is secured, are provided in the package 3. In FIG. 1, an interior space in the package 3 is denoted by the reference sign 2, and an exterior space around the package (surroundings) is denoted by the reference sign 11. Here, the pressure relief valve 1 has the function of releasing any excess pressure that arises in the package 3 to the outer side 11 and to seal off any vacuum prevailing in the package 3 from the outer side.

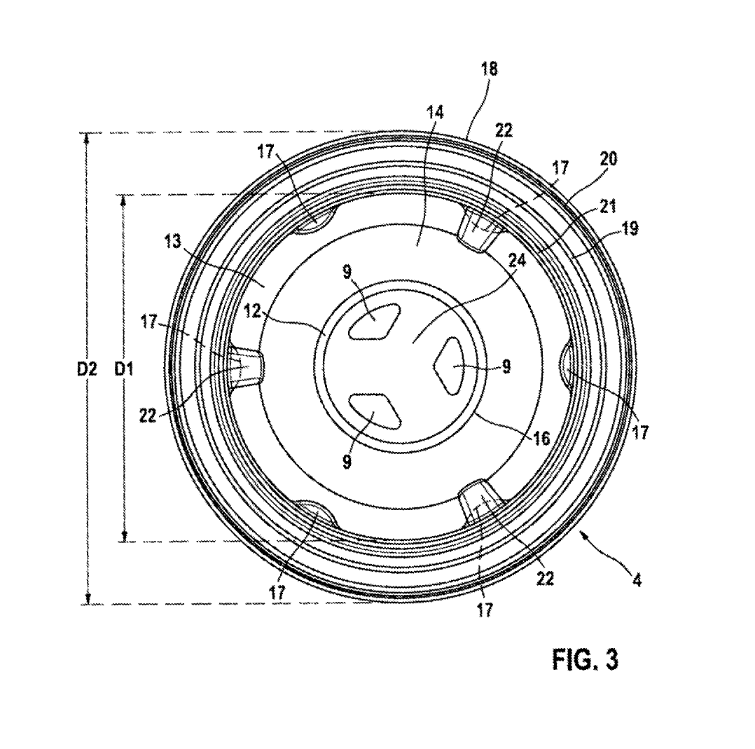

The main body 4 is designed to be cylindrical or slightly conical and relatively short and comprises a peripheral region 18 and a recess 10, in which the diaphragm 6 is arranged. As can be seen from FIG. 1, the recess 10 defines a space 111 in the assembled condition of the pressure relief valve, said space being bounded by the remainder of the main body and by part of the inner wall 3a of the package 3. The main body 4 furthermore has a sealing surface 14 and a central bottom region 24. Three through holes 9 (FIG. 3), via which gas can flow out if there is excess pressure in the package, are formed in the central bottom region 24. An inner annular groove 12 and an outer annular groove 13 are furthermore formed in the main body 4. As can be seen from FIG. 1, the outer annular groove 13 merges directly into the peripheral region 18. Three hold-down elements 22 and a plurality of radially inward-projecting noses 17 for centering the diaphragm 6 are furthermore formed integrally on the peripheral region 18, i.e. the hold-down elements 22 and the noses 17 are formed integrally with the main body 4. The arrangement of the noses 17 on the encircling ring forms a particularly space-saving arrangement. The peripheral region 18 furthermore comprises a central ring 19, an outer ring 20 and an inner ring 21. In the as yet unsealed condition, as shown in FIG. 2, the central ring 19 projects further from a base surface 25 than the outer ring 20 and the inner ring 21. As can further be seen from FIG. 2, an outer edge 15 is formed at the transition between the sealing surface 14 and the outer annular groove 13. An inner edge 16 is furthermore formed at the transition between the sealing surface 14 and the inner annular groove 12. As can likewise be seen from FIG. 2, the sealing surface 14 is formed in such a way as to taper radially inward. At the same time, the sealing surface 14 has a slightly conical shape, with the outer edge 15 lying at a level perpendicular to a center line X-X which is closer to the inner side 3a of the package than a level of an inner edge 16.

This conical design of the sealing surface 14 ensures that the thickness of a fluid 5 arranged between the main body 4 and the diaphragm 6 varies in the radial direction at the sealing surface 14. Here, a layer of fluid in the region of the outer edge 15 is thinner than in the region of the inner edge 16. Owing to the differences in the thickness of the layer of fluid, different adhesion forces and capillary forces are thus obtained, and these have a significant influence on the opening and closing behavior of the diaphragm. More powerful adhesive forces occur at the outer edge 15, at which the thickness of the layer of fluid is less, thereby enabling improved vacuum tightness to be obtained. In contrast, the thickness of the layer of fluid in the region of the inner edge 16 is somewhat greater and, as a result, the adhesion forces or capillary forces are somewhat less powerful there, making it possible to accomplish a diaphragm opening process more easily from there.

As can furthermore be seen from FIG. 1, the recess 10 has a first diameter D1, which is about 75% of an outside diameter D2 of the main body 4 (D1=0.75×D2). It is thereby possible to ensure that the main body 4 and hence also the pressure relief valve 1 have only very small dimensions since the peripheral region 18 merges into the sealing surface 14 with only the outer annular groove 13 separating them. Owing to the very small dimensions of the pressure relief valve 1, there can be very wide variation in the positioning thereof on the package 3. In particular, it is thereby possible to adapt to different parameters of the package, e.g. the external shape or material of the package. The outside diameter D2 of the main body is about 14.5 mm. By means of the small dimensions of the main body 4, it is also possible to ensure that the diaphragm 4 extends almost as far as the peripheral region 18, there being a small gap here between the diaphragm 6 and the peripheral region 18 in order to allow any gas that is to be released from the package to flow out. A filter 8 is furthermore arranged on that side 7 of the main body 4 which is oriented toward the interior space 2.

The compact pressure relief valve 1 according to the invention operates as follows. When there is a pressure in the package 3 above an ambient pressure on the outer side 11, a fourth dependent on the sum of the cross sections of the through openings 9 acts on the diaphragm 6 from the inside. In this case, the diaphragm 6 rests on the central bottom region 24. Since the diaphragm 6 is flexible and the central bottom region 24 lies in a plane perpendicular to the center line X-X, the diaphragm can be raised relatively easily from there, even at a small excess pressure of less than 500 Pa. Since a fluid is additionally provided on the sealing surface 14, capillary and adhesive forces associated with the layer of fluid counteract in this case the pressure-induced force acting on the diaphragm. These capillary and adhesive forces fundamentally decrease as the thickness of the layer of fluid increases. Since the thickness of the layer of fluid is greater in the region of the inner edge 16 than in the region of the outer edge 15, comparatively weak pressure-induced forces are required to overcome the capillary and adhesive forces in the region of the inner edge 16. Owing to the flexibility of the diaphragm 6, the area of application of the internal excess pressure increases, thus enabling the more powerful capillary and adhesive forces to be overcome more easily in the region of the outer edge 15, until the valve opens.

When there is a vacuum in the interior space 2 of the package relative to the outer side 11, on the other hand, the powerful capillary and adhesive forces act in the region of the outer edge 15 and thus hold the diaphragm reliably and sealingly on the sealing surface 14. As a result, the pressure relief valve according to the invention has a high vacuum tightness.

It should be noted that it is also possible for a level of the central bottom region 24 to be somewhat lower than a level of the inner edge 16. Moreover, if a soft or deformable surface is formed on a surface of the diaphragm 6 which is oriented toward the sealing surface 14, this surface on the one hand promotes vacuum tightness owing to the deformability thereof and, in particular, the tapering arrangement of the sealing surface 14 additionally promotes the formation of a layer of fluid with different thicknesses in the region of the outer edge 15 and the region of the inner edge 16.

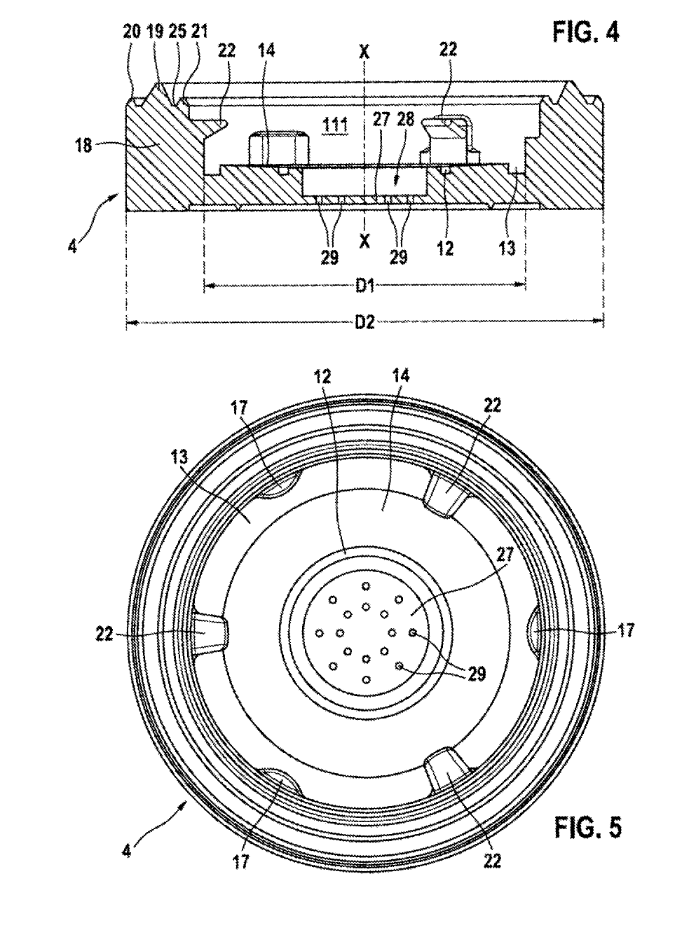

A pressure relief valve in accordance with a second illustrative embodiment of the invention is described below with reference to FIGS. 4 and 5, with parts that are the same or have the same function being denoted by the same reference signs as in the first illustrative embodiment.

As can be seen from FIGS. 4 and 5, the second illustrative embodiment corresponds substantially to the first illustrative embodiment. In contrast, a central bottom region which has a depression 28 and a bottom surface 27 is provided instead of a solid central bottom region 24.

A perforation comprising a multiplicity of microholes 29 is provided in the bottom surface 27. The microholes 29 each have a diameter of from 30 to 120 μm and, as can be seen from FIG. 5, are arranged on a plurality of concentric circles. The microholes 29 are provided in a symmetrical arrangement. Using the microholes makes it possible, in particular, to dispense with the filter 8, thus allowing a further reduction in the number of components for the pressure relief valve. In other respects, this illustrative embodiment corresponds to the first illustrative embodiment and reference can therefore be made to the description given in that context.

1. A pressure relief valve for a packaging container (3), comprising
a main body (4) with at least one through opening (9, 29), a sealing surface (14) and a peripheral region (18), wherein the peripheral region (18) can be sealingly connected to an inner side (3a) of the packaging container (3) and wherein the sealing surface (14) has an inwardly tapering form, and
a flexible diaphragm (6), which rests on the sealing surface (14) of the main body (4) in order to bring about a sealing effect, the diaphragm (6) covering the through opening (9), and a fluid (5) being arranged between the sealing surface (14) and the diaphragm (6),
wherein a recess (10) to accommodate the diaphragm (6) is formed in the main body (4), the recess (10) having a first diameter (D1), which has between 70 and 80% of a total diameter (D2) of the main body (4).

2. The pressure relief valve as claimed in claim 1, characterized in that an inner annular groove (12) is arranged in the main body (4) radially inward of the sealing surface (14), and a central bottom region (24), in which the through opening (9) is arranged, is formed inward of the inner annular groove (12).

3. The pressure relief valve as claimed in claim 1, characterized in that an outer annular groove (13) is arranged in the main body (4) radially outward of the sealing surface (14), the peripheral region (18) directly adjoining the outer annular groove (13).

4. The pressure relief valve as claimed in claim 1, further comprising a multiplicity of retaining elements (22), which are arranged on the peripheral region (18) and are formed integrally with the main body (4).

5. The pressure relief valve as claimed in claim 1, characterized in that a multiplicity of noses (17) that project radially inward is arranged on the peripheral region (18), the noses (17) centering the diaphragm (6) between them.

6. The pressure relief valve as claimed in claim 2, characterized in that a level of the central bottom region (24) perpendicular to a center line (X-X) corresponds to a level of an inner edge (16) of the sealing surface (14).

7. The pressure relief valve as claimed in claim 1, characterized in that the through opening comprises a bottom surface (27) having a multiplicity of microholes (29).

8. The pressure relief valve as claimed in claim 1, characterized in that the diaphragm (6) has a deformable surface oriented toward the sealing surface (14).

9. The pressure relief valve as claimed in claim 8, characterized in that the deformable surface of the diaphragm (6) is produced from EPDM or NBR or silicone rubber.

10. The pressure relief valve as claimed in claim 1, characterized in that the peripheral region (18) of the main body (4) has an inner ring (21), an outer ring (20) and a central ring (19) before being connected to the packaging container (3) in a sealing operation, the central ring (19) projecting further outward from a base surface (25) than the inner ring (21) and the outer ring (20).

11. The pressure relief valve as claimed in claim 1, characterized in that the through opening comprises a bottom surface (27) having a multiplicity of microholes (29), the microholes (29) having a mean diameter of between 30 and 120 μm.

12. The pressure relief valve as claimed in claim 2, characterized in that an outer annular groove (13) is arranged in the main body (4) radially outward of the sealing surface (14), the peripheral region (18) directly adjoining the outer annular groove (13).

13. The pressure relief valve as claimed in claim 12, further comprising a multiplicity of retaining elements (22), which are arranged on the peripheral region (18) and are formed integrally with the main body (4).

14. The pressure relief valve as claimed in claim 13, characterized in that a multiplicity of noses (17) that project radially inward is arranged on the peripheral region (18), the noses (17) centering the diaphragm (6) between them.

15. The pressure relief valve as claimed in claim 14, characterized in that a level of the central bottom region (24) perpendicular to a center line (X-X) corresponds to a level of an inner edge (16) of the sealing surface (14).

16. The pressure relief valve as claimed in claim 15, characterized in that the through opening comprises a bottom surface (27) having a multiplicity of microholes (29).

17. The pressure relief valve as claimed in claim 16, characterized in that the diaphragm (6) has a deformable surface oriented toward the sealing surface (14).

18. The pressure relief valve as claimed in claim 17, characterized in that the deformable surface of the diaphragm (6) is produced from EPDM or NBR or silicone rubber.

19. The pressure relief valve as claimed in claim 18, characterized in that the peripheral region (18) of the main body (4) has an inner ring (21), an outer ring (20) and a central ring (19) before being connected to the packaging container (3) in a sealing operation, the central ring (19) projecting further outward from a base surface (25) than the inner ring (21) and the outer ring (20).
